(19) United States
(12) Patent Application Publication
(10) Pub. No.: US 2020/0023441 A1
(43) Pub. Date: Jan. 23, 2020

(54) HALFWAY CUTTER CHANGING METHOD FOR LARGE-AREA MICROSTRUCTURE CUTTING BASED ON IN-SITUATION FILM THICKNESS MEASUREMENT

(71) Applicant: Beijing Institute of Technology, Beijing (CN)

(72) Inventors: Tianfeng ZHOU, Beijing (CN); Benshuai RUAN, Beijing (CN); Jia ZHOU, Beijing (CN); Longlong TANG, Beijing (CN); Zhiqiang LIANG, Beijing (CN); Li JIAO, Beijing (CN); Zhibing LIU, Beijing (CN); Lijing XIE, Beijing (CN); Pei YA N, Beijing (CN); Xibin WANG, Beijing (CN)

(73) Assignee: Beijing Institute of Technology

(21) Appl. No.: 16/499,647

(22) PCT Filed: Feb. 18, 2019
(86) PCT No.: PCT/CN2019/075327

§ 371 Date: Sep. 30, 2019

(30) Foreign Application Priority Data
Feb. 27, 2018 (CN) 201810163877.0

(51) Int. Cl. B23B 1/00; G01B 11/06

(52) U.S. Cl. CPC B23B 1/00; G01B 11/0641

(57) ABSTRACT

The present invention demonstrates a halfway cutter changing method for large-area microstructure cutting based on in-situation film thickness measurement, including the following steps: step 110: preparatory work; step 120: workpiece preliminary machining; step 130: transparent film coating; step 140: film thickness detection; step 150: halfway cutter changing; and step 160: machining completion. The halfway cutter changing method for the large-area microstructure cutting based on the in-situation film thickness measurement provided by the present invention implements machining of a microstructure with large area, high quality and high uniformity.

### TECHNICAL FIELD

The present invention relates to the technical field of ultra-precision cutting, and in particular to a halfway cutter changing method for large-area microstructure cutting based on in-situation film thickness measurement.

### BACKGROUND

In an ultra-precision cutting process, it is difficult to complete machining of microstructure with large area, high quality and high uniformity due to the wear of cutter. The existing technologies reduce the wear of cutter mainly by reducing the cutting thickness, performing material surface modification, using coated cutter, spraying cutting fluid, lubricating solid particle to implement ultra-precision machining of microstructure with large area, high quality and high uniformity.

In an existing solution, reducing the cutting thickness may reduce the wear of the cutter appropriately, but the machining efficiency is relatively low, which fails to meet the requirements of high efficiency and high economy. Although the machining for a certain area of high-quality microstructure may be met, the machining for a large area cannot be implemented.

By adopting a material modification method, a surface layer of a machined material may be changed into a soft and easily-machinable material. However, it is difficult to guarantee that the thickness of modified layer is uniform, and the cutting depth remains the same as the thickness of the deformed layer during the cutting process. When the cutting depth is greater than the thickness of the modified layer, the cutter tip is equivalent to machine a hard material directly and thus the cutter will be worn seriously. When the cutting depth is smaller than the thickness of the modified layer, the wear of the cutter may be effectively prevented; nonetheless, because of the residue of modified layer on the workpiece, performances such as hardness and strength of the workpiece are reduced and thus the use requirement cannot be met.

With the adoption of the coated cutter, the surface hardness of cutter is increased, a friction coefficient between the cutter and the machined material is reduced, and the purpose of reducing the wear of the cutter may be implemented, so that the machining for a certain large area of microstructure can be met. However, when a cutting distance is increased to a certain value, the wear of the coated cutter still cannot be ignored, and the coating may fall off easily. As a result, the machining for the large area of the high-quality microstructure cannot be implemented.

Methods of spraying cutting fluid and lubricating solid particle can reduce the wear between cutter and machined material. However, spraying cutting fluid and lubricating solid particle will pollute the environment to a certain extent and do not meet the requirement of environmental protection. Furthermore, a solid lubricated particle is adhered to the surface of the microstructure, which reduces the precision of microstructure.

The existing technologies can reduce the wear of the cutter to a certain extent but cannot prevent the wear of the cutter, so all cannot implement the machining of the microstructure with the large area, the high quality and the high uniformity.

### SUMMARY

An objective of the present invention is to provide a halfway cutter changing method for large-area microstructure cutting based on in-situation film thickness measurement, to solve the problems in existing technologies and implement machining of a microstructure with a large area, high quality and high uniformity.

To achieve the above purpose, the present invention provides the following solution.

The present invention provides a halfway cutter changing method for large-area microstructure cutting based on in-situation film thickness measurement, including the following steps:

step 110: self-cutting of a vacuum chuck: machining, by turning/milling, the vacuum chuck on a spindle of a machine tool to be flat;

step 120: workpiece flat machining: mounting the workpiece to the vacuum chuck, performing end surface flat machining on the workpiece, and making the microstructure to-be-machined workpiece to be completely planarly parallel to the vacuum chuck;

step 130: film coating: coating a transparent film on a machined surface of the workpiece, using a cutter to turn/mill the transparent film to be flat, meanwhile, recording a Z₀ point by the machine tool;

step 140: measuring the film thickness: using an in-situation measuring device to measure the thickness T₀ of the coated film, and when a depth of a machined microstructure is D, only feeding the cutter for T₀+D based on the determined reference point Z₀ so that the machining can be started;

step 150: halfway cutter changing: when the cutter for cutting is worn, repeating the step 130, performing plane turning/milling machining on the remaining film once again, meanwhile, recording a Z₁ point by the machine tool; and repeating the step 140, measuring a thickness T₁ of the film, and feeding for T₁+D to perform the machining of the microstructure continuously;

step 160: machining completion: successively repeating the above steps till the whole microstructure is machined completely;

step 170: film removal: if necessary, placing the machined workpiece into an organic solvent to dissolve, cleaning and drying to obtain a machined workpiece with microstructure array.

Optionally, the online measuring device in the step 140 is an ellipsometer; and the ellipsometer includes a light source, a polarizer and a wave plate located on a same straight line, as well as a polarization analyzer and a photoelectric detector angularly disposed with a connection line for the light source, the polarizer and the wave plate.

Optionally, a measurement accuracy of the ellipsometer is 0.1 nm.

Optionally, the transparent material is a transparent film; and the transparent film is made of a room temperature easily-curable film forming material such as polymethyl methacrylate (PMMA), polypropylene (PP), polyvinyl chloride (PVC), polystyrene (PS), polycarbonate (PC) or polyethylene terephthalate (PET).

Optionally, the vacuum chuck is made of an aluminum alloy material.

Optionally, the cutter is an arc turning cutter or a plane end milling cutter/ball end milling cutter. Specifically, the cutter includes a turning cutter and a milling cutter; the turning cutter is an arc turning cutter; and the milling cutter is a plane end milling cutter/ball end milling cutter.

Compared with the prior art, the halfway cutter changing method for the large-area microstructure cutting based on the in-situation film thickness measurement provided by the present invention achieves the following technical effects:

When the halfway cutter changing method for the large-area microstructure cutting based on the in-situation film thickness measurement provided by the present invention is in work, since the measurement accuracy of the online measurement device is 0.1 nm, an error of the reference point of the cutter may be controlled at a nano level and the error of the reference point for changing the cutter may be ignored. With the method provided by the present invention, the machining error caused by wear of the cutter during the cutting process can be prevented, and the machining of the microstructure with the large area, the high quality and the high uniformity is implemented.

### BRIEF DESCRIPTION OF THE DRAWINGS

To describe the technical solutions in the embodiments of the present invention or in the prior art more clearly, the following briefly describes the accompanying drawings required for describing the embodiments. Apparently, the accompanying drawings in the following description show some embodiments of the present invention, and a person of ordinary skill in the art may still derive other drawings from these accompanying drawings without creative efforts.

FIG. 1 is a work flowchart of a halfway cutter changing method for large-area microstructure cutting based on in-situation film thickness measurement provided by the present invention.

In the FIGURE: 1. cutter, 2. vacuum chuck, 3. workpiece, 4. transparent film, and 5. ellipsometer.

### DETAILED DESCRIPTION

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

An objective of the present invention is to provide a halfway cutter changing method for large-area microstructure cutting based on in-situation film thickness measurement, to solve the problems of the above prior art, and implement machining of a microstructure with large area, high quality and high uniformity.

To make the foregoing objective, features, and advantages of the present invention clearer and more comprehensible, the present invention is further described in detail below with reference to the accompanying drawings and specific embodiments.

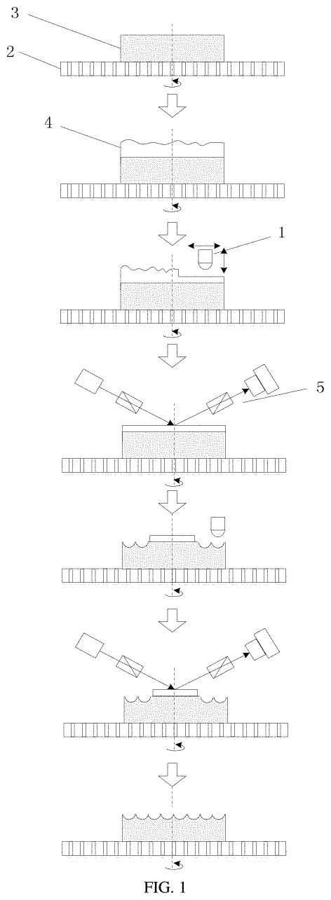

Referring to FIG. 1, a numeral 2 in FIG. 1 represents a vacuum chuck, and the vacuum chuck 2 may rotate around a rotating axes; a numeral 1 represents a cutter, and the cutter may be fed and rotate as instructed; a numeral 5 represents an ellipsometer, which includes a light source, a polarizer and a wave plate located on a same straight line, as well as a polarization analyzer and a photoelectric detector angularly disposed with a connection line for the light source, the polarizer and the wave plate; and a thickness of a transparent film 4 may be measured accurately by using the ellipsometer 5.

### Embodiment 1

As shown in FIG. 1, this embodiment provides a halfway cutter changing method for large-area microstructure cutting based on in-situation film thickness measurement. Specifically, a vacuum chuck 2 made of an aluminum alloy material is turned/milled by a cutter 1 to be flat first. A machined workpiece 3 is mounted to the vacuum chuck 2, end surface flat machining is performed on the workpiece 3, meanwhile, a machined plane of the workpiece 3 is completely parallel to the vacuum chuck 2.

A transparent material (a room temperature easily-curable film forming material such as PMMA, PP, PVC, PS, PC and PET) is coated on the machined surface of the ultrahard material workpiece to form a transparent film 4, the cutter 1 is used to turn/mill it to be flat, meanwhile, a machine tool records a Z₀ point. An ellipsometer 5 is used to measure a thickness T₀ of the coated transparent film 4, and when a depth of a machined microstructure is D, the cutter is only fed for T₀+D based on the determined reference point Z₀ so that the machining can be started.

When a cutting distance is accumulated to a certain length, the wear of the cutter 1 cannot be ignored. If the same cutter 1 is used continuously to machine, the machining of the microstructure with high quality, large area and high uniformity cannot be completed. In order to continuously complete the machining of the microstructure, a cutter 1 need to be changed or a blade is selected to be ground and reinstalled at this time. After the cutter is changed, in order to determine a reference point of the cutter, a remaining transparent film material is coated on a to-be-machined surface once again to form a transparent film 4, the plane turning/milling machining is performed, meanwhile, the machine tool records a Z₁ point; and a thickness T₁ of the transparent film 4 is measured, then the cutter is fed for T₁+D to continuously perform the machining of the microstructure, and the above steps are repeated successively till the whole microstructure is machined completely. Since the measurement accuracy of the ellipsometer 5 is 0.1 nm, an error of the reference point of the cutter may be controlled at a nano level and the error of the reference point for changing the cutter may be ignored. With the method provided by the present invention, a machining error caused by wear of the cutter in a cutting process can be prevented, and the machining of the microstructure with the large area, the high quality and the high uniformity is implemented.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the content of this specification shall not be construed as a limitation to the invention.

What is claimed is:

1. A halfway cutter changing method for large-area microstructure cutting based on in-situation film thickness measurement, comprising the following steps:
step 110: self-cutting of a vacuum chuck: machining, by turning/milling, the vacuum chuck on a spindle of a machine tool to be flat;
step 120: workpiece flat machining: mounting a workpiece to the vacuum chuck, performing end surface flat machining on the workpiece, and making the microstructure to-be-machined workpiece to be completely planarly parallel to the vacuum chuck;
step 130: film coating: coating a transparent film on a machined surface of the workpiece, using a cutter to turn/mill the transparent film to be flat, meanwhile, recording a Z₀ point by the machine tool;
step 140: film thickness detection: using an online measuring device to measure a thickness T₀ of the coated film, and when a depth of a machined microstructure is D, only feeding the cutter for T₀+D based on the determined reference point Z₀ so that the machining can be started;
step 150: halfway cutter changing: when the cutter for cutting is worn, repeating the step 130, performing plane turning/milling machining on a remaining film once again, meanwhile, recording a Z₁ point by the machine tool; and repeating the step 140, measuring a thickness T₁ of the film, and feeding for T₁+D to perform the machining of the microstructure continuously;
step 160: machining completion: successively repeating the above steps till the whole microstructure is machined completely; and
step 170: film removal: if necessary, placing a machined workpiece into an organic solvent to dissolve, cleaning and drying to obtain a machined workpiece having a microstructure array on a surface.

2. The halfway cutter changing method for the large-area microstructure cutting based on the in-situation film thickness measurement according to claim 1, wherein the online measuring device in the step 140 is an ellipsometer; and the ellipsometer comprises a light source, a polarizer and a wave plate located on a same straight line, as well as a polarization analyzer and a photoelectric detector angularly disposed with a connection line for the light source, the polarizer and the wave plate.

3. The halfway cutter changing method for the large-area microstructure cutting based on the in-situation film thickness measurement according to claim 2, wherein a measurement accuracy of the ellipsometer is 0.1 nm.

4. The halfway cutter changing method for the large-area microstructure cutting based on the in-situation film thickness measurement according to claim 3, wherein the transparent material is a transparent film; and the transparent film is made of a room temperature easily-curable film forming material such as polymethyl methacrylate (PMMA), polypropylene (PP), polyvinyl chloride (PVC), polystyrene (PS), polycarbonate (PC) or polyethylene terephthalate (PET).

5. The halfway cutter changing method for the large-area microstructure cutting based on the in-situation film thickness measurement according to claim 4, wherein the vacuum chuck is made of an aluminum alloy material.

6. The halfway cutter changing method for the large-area microstructure cutting based on the in-situation film thickness measurement according to claim 5, wherein the cutter is an arc turning cutter or a plane end milling cutter/ball end milling cutter.
